(19) United States
(12) Patent Application Publication
(10) Pub. No.: US 2004/0247187 A1
(43) Pub. Date: Dec. 9, 2004

(54) Image coding apparatus

(76) Inventors: Yasushi Tanaka, Toyonaka-shi (JP); Akihiko Otani, Minoo-shi (JP); Akihiko Watabe, Kashiba-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/850,365

(22) Filed: May 21, 2004

(30) Foreign Application Priority Data
May 23, 2003 (JP) 2003-146890

(51) Int. Cl. G06K 9/36

(52) U.S. Cl. 382/232

(57) ABSTRACT

An image coding apparatus for generating two different types of coded data from a single piece of image data comprises a memory in which the input image data and the like are stored, a motion detector, a first encoder, and a second encoder. The second encoder performs quantization, variable-length coding, and control of generated code amount by settings different from those of the first encoder, on the basis of the output from a DCT, thereby generating second coded data that is different from first coded data generated by the first encoder. Therefore, it is possible to provide an image coding apparatus having no increase in circuit scale and processing time when generating plural pieces of coded data from a single input image.

### FIELD OF THE INVENTION

The present invention relates to a digital signal recording/reproduction apparatus for digitally recording and reproducing a video signal and an audio signal, such as a video tape recorder and a video disk recorder, and an image coding apparatus included in a broadcasting apparatus for digitizing a video signal and an audio signal to distribute the digital signals. More particularly, the invention relates to an image coding apparatus for generating a plurality of coded data from a single input image.

### BACKGROUND OF THE INVENTION

In a digital signal recording/reproduction apparatus for digitally recording and reproducing a video signal and an audio signal or a broadcasting apparatus for digitizing the video signal and the audio signal to distribute the digital signals, it is necessary to compress (encode) an enormous amount of data of the digital video signal to be processed in the apparatus, thereby to reduce the size of the apparatus. There are various methods for compressing (encoding) a digital video signal as follows: motion compensating prediction, orthogonal transform (especially, discrete cosine transform: DCT), band division, sampling by quantization, variable-length coding (VLC) such as Huffman coding, and arithmetic coding (refer to Japanese Published Patent Application No. 10-108199, pages 4 to 6, FIG. 1).

As described above, when generating coded data by compressing (encoding) a single digital video signal inputted to the above-mentioned digital signal recording/reproduction apparatus or broadcasting apparatus by using an image coding unit included in the apparatus, there are cases where a plurality of coded data may be generated, and furthermore, there are cases where the code amounts of the plural coded data so generated or the formats thereof may vary depending on performance of a decoding apparatus that receives and decodes the generated coded data.

FIG. 6 is a block diagram illustrating a conventional image coding apparatus for coding an inputted single digital video signal into two pieces of coded data having different generated code amounts. Hereinafter, the construction of the conventional image coding apparatus will be described.

With reference to FIG. 6, the conventional image coding apparatus 50 comprises first and second motion detectors 518 and 528 for obtaining motion vectors of an inputted image data S50; first and second encoders 510 and 520 for coding the inputted image data using the motion vectors obtained in the first and second motion detectors 518 and 528 to output first and second coded data S51 and S52, respectively; and a memory 500 for holding the inputted image data S50, and first and second locally-reproduced image data S514 and S524 which are reconstructed by the first and second encoders 510 and 520, respectively. The first encoder 510 comprises a first motion compensation unit 511 for performing motion compensation using the motion vector supplied from the first motion detector 518 to generate difference data S511; a first DCT unit 512 for performing DCT on the difference data S511 outputted from the first motion compensation unit 511; a first quantizer 513 for performing quantization, i.e., dividing the DCT (discrete cosine transformed) difference data S512 by a quantization factor; a first variable-length encoder 516 for coding the quantized data; a first inverse quantizer 514 for inversely quantizing the quantized data; a first inverse DCT unit 515 for performing IDCT on the inversely quantized data to restore the data to the original data S515 that has not yet been subjected to DCT by the first DCT unit 512; and a first coded data amount controller 517 for controlling the quantization factor of the first quantizer 513 on the basis of the amount of data coded by the first variable-length encoder 516, thereby controlling the amount of coded data to be outputted from the image coding apparatus 50. Since the construction of the second encoder 520 is identical to that of the first encoder 510, repeated description is not necessary.

Hereinafter, the operation of the image coding apparatus 50 constructed as described above will be described.

First of all, when the image data S50 is input to the image coding apparatus 50 from the outside, the image data S50 is stored in the memory 500. The image data stored in the memory 500 is input to the first and second motion detectors 518 and 528, respectively, wherein motion vectors are obtained. The first and second motion compensation units 511 and 521 generate first and second prediction image data S513 and S523, using the motion vectors detected by the first and second motion detectors 518 and 528, with reference to the first and second locally-reproduced image data S514 and S524 stored in the memory 500, and output the generated data S513 and S523 to adders in the encoders 510 and 520, respectively. Further, the first and second motion compensation units 511 and 521 calculate a difference between the first prediction image data S513 and the input image data 350 and a difference between the second prediction image data S523 and the input image data S50, respectively, and output the differences as first and second difference data S511 and S521 to the first and second DCT units 512 and 522, respectively.

The first and second difference data S511 and S521 obtained in the first and second motion compensation units 511 and 521 are subjected to DCT by the first and second DCT units 512 and 522, respectively. Then, the first and second DCT data S512 and S522 are subjected to quantization by the first and second quantizers 513 and 523, respectively, i.e., the respective data are divided by the first and second quantization factors. Thereafter, the quantized data are respectively coded by the first and second variable-length encoders 516 and 526 to obtain first and second coded data S51 and S52. Simultaneously, the first and second coded data S51 and S52 obtained in the first and second variable-length encoders 516 and 526 are also input to the first and second generated code amount controllers 517 and 527, wherein the first and second quantization factors of the first and second quantizers 513 and 523 are controlled on the basis of the code amounts of the first and second coded data S51 and S52, thereby to bring the generated code amounts of the first and second coded data S51 and S52 close to a predetermined value, respectively.

Furthermore, the data quantized by the first and second quantizers 513 and 523 are subjected to inverse quantization by the first and second inverse quantizers 514 and 524 and inverse DCT by the first and second IDCT units 515 and 525, respectively, thereby restoring the quantized data to the original first and second difference data S515 and S525 that have not yet been subjected to the above-mentioned DCT processing, respectively. Then, the adder included in the encoder 510 adds the first difference data S515 outputted from the first IDCT unit 515 and the first predictive image data S513 generated in the first motion compensation unit 511 while the adder included in the encoder 520 adds the second difference data S525 outputted from the second IDCT unit 525 and the second predictive image data S523 generated in the second motion compensation unit 521, thereby reconstructing the first and second locally-reproduced image data S514 and S524, which are image data to be obtained by decoding apparatuses that receive the first and second coded data S51 and S52, respectively, and the reconstructed data are stored in the memory 500.

As described above, when plural pieces of coded data are obtained from a single image input in the conventional image coding apparatus 50, the image coding apparatus 50 is provided with the motion detectors and encoders as many as the number of coded data to be outputted from the image coding apparatus 50, and plural pieces of coded data of different types are generated from the single image data inputted to the image coding apparatus 50 according to, for example, performances of decoders paired with the respective encoders.

Generally, in the conventional image coding apparatus 50, the first (second) motion detector 518 (528) has a circuit scale about several to ten times as large as that of the first (second) encoder 510 (520). Further, the amount of data transferred from the memory 500 to the first (second) motion detector 518 (528) is also about several to ten times as large as that of the first (second) encoder 510 (520). Further, required computing ability of the first (second) motion detector 518 (528) is about one hundred times as high as that of the first (second) encoder 510 (520).

Accordingly, when the image coding apparatus 50 is provided with motion detectors and encoders as many as the number of coded data to be generated as shown in FIG. 6 to obtain plural pieces of coded data from a single image input, the scale of the image coding apparatus 50 is considerably increased as compared with the case where a single piece of coded data is obtained from a single image input.

In order to avoid such increase in the circuit scale of the conventional image coding apparatus, the image coding apparatus may be provided with a single motion detector and a single encoder to generate plural pieces of coded data from a single piece of image data by using the same circuit resource. In this case, however, since plural pieces of coded data must be generated by using the only one motion detector and the only one encoder, the processing abilities of the motion detector and the encoder must be enhanced in proportion to the number of coded data to be generated from the single image data. In addition, the processing time is undesirably increased. Furthermore, the amount of data transferred from the memory to the motion detector and the encoder is also increased in proportion to the number of coded data to be generated in the image coding apparatus, it becomes necessary to extend the width of memory interface in the image coding apparatus or increase the data transfer rate in order to increase the transfer ability. As the result, the system cost of the image coding apparatus is undesirably increased.

### SUMMARY OF THE INVENTION

The present invention is made to solve the above-described problems and has for its object to provide an image coding apparatus for generating plural pieces of coded data from a single piece of input image data, without increasing the circuit scale and processing time required for coding, thereby to realize a reduction in system cost as compared with an image coding apparatus for outputting a single piece of coded data from a single piece of image data.

Other objects and advantages of the invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided an image coding apparatus for outputting a plurality of coded data of different types from a single input image, and the apparatus comprises: a motion detector for obtaining a motion vector of the input image; a first encoder for subjecting the input image to motion compensation using the motion vector obtained by the motion detector, quantizing the data that is obtained by subjecting the motion-compensated data to orthogonal transformation, and subjecting the orthogonally-transformed data to variable length coding, thereby generating first coded data; and n (n: integer, n≧1) pieces of encoders, each receiving the data that is orthogonally-transformed by the first encoder, quantizing the data, and subjecting the quantized data to variable-length coding, thereby generating coded data. Therefore, the scale of the image coding apparatus for generating plural pieces of coded data from a single piece of input image data is significantly reduced, and the processing time required for the image coding apparatus to generate the plural pieces of coded data from the single piece of image data is hardly increased as compared with the processing time required for generating a single piece of coded data from a single piece of input image data. Further, the amount of data transferred in the image coding apparatus for generating the plural pieces of coded data from the single piece of image data is made equal to that in the case of generating a single piece of coded data from a single piece of input image data, resulting in a reduction in system cost.

According to a second aspect of the present invention, in the image coding apparatus according to the first aspect, the first encoder comprises a motion compensation unit for subjecting the input image to motion compensation using the motion vector, an orthogonal transformer for subjecting the motion-compensated data to orthogonal transformation, a first quantizer for quantizing the orthogonally-transformed data, an inverse quantizer for inversely quantizing the quantized data, an inverse orthogonal transformer for subjecting the inversely-quantized data to inverse orthogonal transformation, a first variable-length encoder for subjecting the quantized data to variable-length coding to generate first coded data, and a generated code amount controller for controlling the first quantizer on the basis of tile code amount of the first coded data that is generated by the first variable-length encoder; and each of the n pieces of encoders comprises a quantizer for quantizing the data that is orthogonally-transformed by the first encoder, a variable-length encoder for subjecting the quantized data to variable-length coding to generate coded data, and a generated code amount controller for controlling the quantizer on the basis of the code amount of the coded data obtained by the variable-length encoder. Therefore, the scale of the image coding apparatus for generating plural pieces of coded data from a single piece of input image data is significantly reduced, and the processing time required for the image coding apparatus to generate the plural pieces of coded data from the single piece of image data is hardly increased as compared with the processing time required for generating a single piece of coded data from a single piece of input image data. Further, the amount of data transferred in the image coding apparatus for generating the plural pieces of coded data from the single piece of image data is made equal to that in the case of generating a single piece of coded data from a single piece of input image data, resulting in a reduction in system cost.

According to a third aspect of the present invention, in the image coding apparatus according to the second aspect, the n pieces of encoders perform coding to generate n pieces of coded data so that the code amount of the n pieces of coded data becomes smaller than the code amount of the first coded data. Therefore, a first error that occurs when generating the first coded data is reduced and, simultaneously, a second error including the first error, which occurs when generating the second coded data, is also reduced. As a result, favorable image quality is obtained at a decoding apparatus side that receives and decodes the second coded data.

According to a fourth aspect of the present invention, in the image coding apparatus according to the third aspect, the n pieces of encoders perform coding to generate n pieces of coded data so that an intra-frame coded image and an inter-frame forward direction predictive coded image have the same code amount as the code amount of the first coded data, while an inter-frame bidirectional predictive coded image has a code amount that is smaller than the code amount of the first coded data. Therefore, it is possible to vary the code amounts of the first and second coded data only when generating the inter-frame bidirectional predictive coded image which is not used as a reference image for coding. Thereby, the first error that occurs when generating the first coded data is further reduced and, simultaneously, the second error including the first error, which occurs when generating the second coded data, is further reduced. As a result, more favorable image quality is obtained at the decoding apparatus side that receives and decodes the second coded data.

According to a fifth aspect of the present invention, in the image coding apparatus according to the second aspect, the first coded data and the n pieces of coded data, which are respectively outputted from the first encoder and the n pieces of encoders, are coded data having the same format and different generated code amounts. Therefore, it is possible to output plural pieces of data according to performances of decoders for receiving and decoding the first coded data and the n pieces of coded data, from the first encoder and the n pieces of encoders, respectively.

According to a sixth aspect of the present invention, in the image coding apparatus according to the second aspect, the first coded data and the n pieces of coded data, which are respectively outputted from the first encoder and the n pieces of encoders, are coded data having different formats. Therefore, it is possible to apply the first coded data and the n pieces of coded data to MPEG1, MPEG2, MPEG4, or the like, respectively, whereby plural pieces of data according to performances of decoders for receiving and decoding the first coded data and the n pieces of coded data can be output from the first encoder and the n pieces of encoders, respectively.

According to a seventh aspect of the present invention, in the image coding apparatus according to the second aspect, the first coded data and the n pieces of coded data, which are respectively outputted from the first encoder and the n pieces of encoders, are coded data having the same format and different stream types. Therefore, it is possible to apply the first coded data and the n pieces of coded data to PS and TS of MPEG2 or the like, respectively, whereby plural pieces of data according to performances of decoders for receiving and decoding the first coded data and the n pieces of coded data can be output from the first encoder and the n pieces of encoders, respectively.

According to an eighth aspect of the present invention, there is provided an image coding apparatus for outputting two different types of coded data from a single input image, and the apparatus comprises: a motion detector for obtaining a motion vector of the input image; a first encoder for subjecting the input image to motion compensation using the motion vector obtained by the motion detector, quantizing the data that is obtained by subjecting the motion-compensated data to orthogonal transformation, and subjecting the orthogonally-transformed data to variable length coding, thereby generating first coded data; and a second encoder for receiving the data that is orthogonally-transformed by the first encoder, quantizing the data, and subjecting the quantized data to variable-length coding, thereby generating second coded data. Therefore, the scale of the image coding apparatus for generating the first and second coded data from a single piece of input image data is significantly reduced, and the processing time required for the image coding apparatus to generate the first and second coded data from the single piece of image data is hardly increased as compared with the processing time required for generating a single piece of coded data from a single piece of input image data. Further, the amount of data transferred in the image coding apparatus for generating the first and second coded data from the single piece of image data is made equal to that in the case of generating a single piece of coded data from a single piece of input image data, resulting in a reduction in system cost.

According to a ninth aspect of the present invention, in the image coding apparatus according to the eighth aspect, the first encoder comprises a motion compensation unit for subjecting the input image to motion compensation using the motion vector, an orthogonal transformer for subjecting the motion-compensated data to orthogonal transformation, a first quantizer for quantizing the orthogonally-transformed data, an inverse quantizer for inversely quantizing the quantized data, an inverse orthogonal transformer for subjecting the inversely-quantized data to inverse orthogonal transformation, a first variable-length encoder for subjecting the quantized data to variable-length coding to generate first coded data, and a generated code amount controller for controlling the first quantizer on the basis of the code amount of the first coded data that is generated by the first variable-length encoder; and the second encoder comprises a second quantizer for quantizing the data that is orthogonally-transformed by the first encoder, a second variable-length encoder for subjecting the quantized data to variable-length coding to generate second coded data, and a second generated code amount controller for controlling the second quantizer on the basis of the code amount of the second coded data obtained by the second variable-length encoder. Therefore, the scale of the image coding apparatus for generating the first and second coded data from a single piece of input image data is significantly reduced, and the processing time required for the image coding apparatus to generate the first and second coded data from the single piece of image data is hardly increased as compared with the processing time required for generating a single piece of coded data from a single piece of input image data. Further, the amount of data transferred in the image coding apparatus for generating the first and second coded data from the single piece of image data is made equal to that in the case of generating a single piece of coded data from a single piece of input image data, resulting in a reduction in system cost.

According to a tenth aspect of the present invention, in the image coding apparatus according to the ninth aspect, one of the first generated code amount controller and the second generated code amount controller variably controls the generated code amount while the other controller fixedly controls the code amount. Therefore, it is possible to variably control one of the code amounts of the first and second coded data while fixedly controlling the other code amount, when generating the first and second coded data from the single piece of input image data.

According to an eleventh aspect of the present invention, the image coding apparatus according to the tenth aspect further comprises a switch for comparing the code amount of the first coded data and the code amount of the second coded data, and switching the output data between the first coded data and the second coded data on the basis of the result of comparison; the first coded data is output as first coded data while the second coded data is output as second coded data when the code amount of the first coded data is larger than the code amount of the second coded data; and the second coded data is output as first coded data while the first coded data is output as second coded data when the code amount of the first coded data is equal to or smaller than the code amount of the second coded data. Therefore, it is possible to make the code amount of the first coded data always larger than the code amount of the second coded data, when generating the first and second coded data from the single piece of input image data. As a result, more favorable image quality is obtained at the decoding apparatus side that receives and decodes the second coded data.

According to a twelfth aspect of the present invention, in the image coding apparatus according to the ninth aspect, the first coded data outputted from the first encoder is coded data in a format for cable, and the second coded data outputted from the second encoder is coded data in a format for radio. Therefore, the first coded data of the larger code amount can be generated in cable format to be output to a network having a broader transmission band, while the second coded data of the smaller code amount can be generated in radio format to be output to a network having a narrower transmission band.

According to a thirteenth aspect of the present invention, in the image coding apparatus according to the ninth aspect, the first coded data outputted from the first encoder is coded data in a format for storage media, and the second coded data outputted from the second encoder is coded data in a format for communication lines. Therefore, the first coded data of the larger code amount can be used for storage media, while the second coded data of the smaller code amount can be used for communication lines.

### BRIEF DESCRIPTION OF THE DRAWINGS

FIG. 1 is a block diagram illustrating an image coding apparatus according to a first embodiment of the present invention.

FIG. 2 is a block diagram illustrating an image coding apparatus according to the first embodiment wherein three or more pieces of coded data are generated.

FIG. 3 is a block diagram illustrating an image coding apparatus according to a second embodiment of the present invention.

FIG. 4 is a block diagram illustrating a detail construction of a switch included in the image coding apparatus according to the second embodiment.

FIGS. 5(a) and 5(b) are diagrams illustrating a change in the amount of generated codes when fixedly controlling the code amount or variably controlling the same in the image coding apparatus according to the second embodiment.

FIG. 6 is a block diagram illustrating a conventional image coding apparatus.

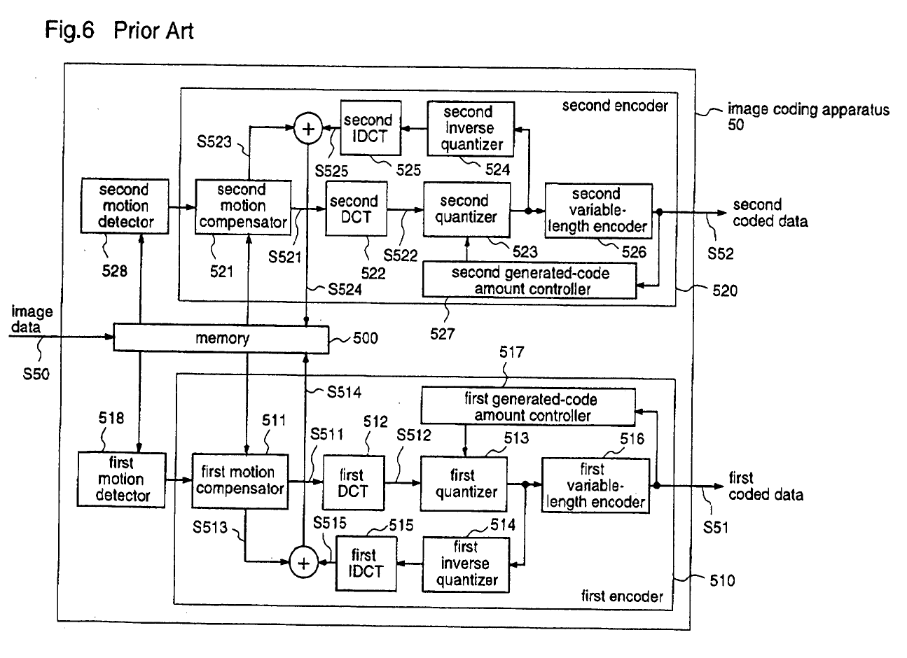

### DETAILED DESCRIPTION OF THE PREFERRED EMBODIMENTS

[Embodiment 1]

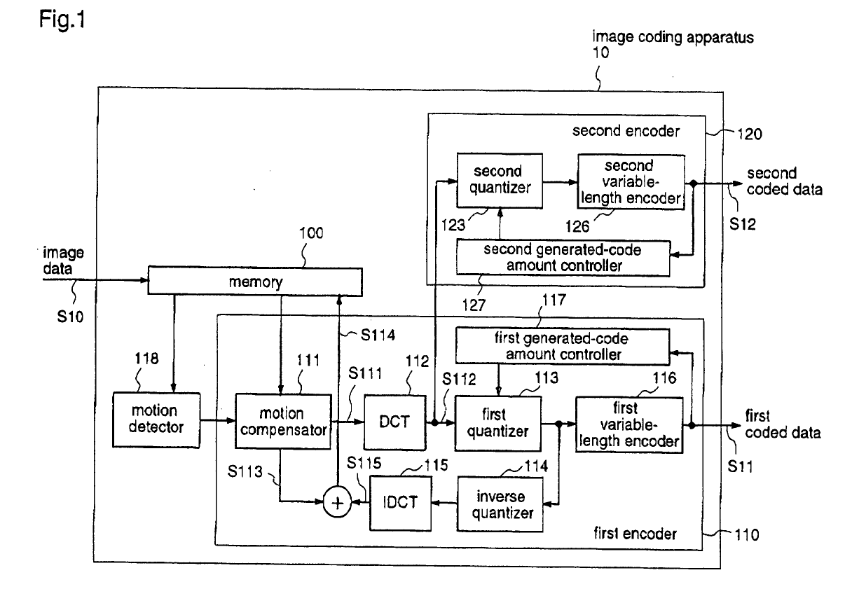

Hereinafter, an image coding apparatus according to a first embodiment of the present invention will be described with reference to FIG. 1.

According to the first embodiment, in an image coding apparatus for generating plural pieces of coded data from a single piece of input image data, a motion detector and an encoder having the conventional constructions are provided for only one piece of coded data (first coded data) among the plural pieces of coded data while no motion detector is provided for the other coded data, and further, the construction of the encoder is simplified, in contrast to the conventional image coding apparatus that is provided with motion detectors and encoders as many as the number of coded data to be generated.

First of all, the construction of the image coding apparatus according to the first embodiment will be described with reference to FIG. 1. In this first embodiment, it is assumed that two kinds of coded data having the same format and different generated code amounts are generated in the image coding apparatus.

In FIG. 1, the image coding apparatus 10 according to the first embodiment comprises a motion detector 118 for detecting a motion vector of an inputted image data S10; first and second encoders 110 and 120 for coding the inputted image data S10 using the motion vector detected by the motion detector 118 to output first and second coded data S11 and S12, respectively; and a memory 100 for holding the inputted image data S10 and locally-reproduced image data S114 that is reconstructed by the first encoder 110. The first encoder 110 includes a motion compensation unit 111, a DCT unit 112, a first quantizer 113, a first variable-length encoder 116, a first generated code amount controller 117, ail inverse quantizer 114, and an IDCT unit 115, as in the construction of the encoder of the conventional image coding apparatus 50. On the other hand, the second encoder 120 includes a second quantizer 123, a second variable-length encoder 126, and a second generated-coded amount controller 127. In contrast to the conventional image coding apparatus 50, the second motion detector, and the motion compensation unit, adder, DCT unit, inverse quantizer, and IDCT unit, which are included in the second encoder, are not included in the image coding apparatus 10.

Next, the operation of the image coding apparatus 10 according to the first embodiment will be described.

Initially, when the image data S10 is supplied from the outside to the image coding apparatus 10, it is stored in the memory 100. The image data stored in the memory 100 is input to the motion detector 118, wherein a motion vector is obtained. Then, the motion compensation unit 111 generates predictive image data S113 using the motion vector detected by the motion detector 118, with reference to the locally-reproduced image data S114 stored in the memory 100, and outputs the data to the adder in the first encoder 110. Further, the motion compensation unit 111 calculates a difference between the predictive image data S113 and the input image data S10, and outputs the difference as difference data S111 to the DCT unit 112.

The difference data S111 obtained in the motion compensation unit 111 is subjected to DCT by the DCT unit 112, and the DCT-processed difference data S112 is input to the first quantizer 113 and to the second quantizer 123 in the second encoder 120. Then, the DCT-processed difference data S112 inputted to the first and second quantizers 113 and 123 are subjected to quantization, i.e., divided by first and second quantization factors, respectively, and then the quantized data are coded by the first and second variable-length encoders 116 and 126 to obtain first and second coded data S11 and S12, respectively. At the same time, the first and second coded data S11 and S12 generated by the first and second variable-length encoders 116 and 126 are also input to the first and second generated code amount controllers 117 and 127, respectively. The first and second generated code amount controllers 117 and 127 control the first and second quantization factors of the first and second quantizers 113 and 123 on the basis of the code amounts of the first and second encoded data S11 and S12 so as to bring the generated code amounts of the first and second coded data S11 and 312 close to a predetermined value, respectively.

Then, the data quantized by the first quantizer 113 is subjected to inverse quantization and inverse DCT by the inverse quantizer 114 and the IDCT unit 115, thereby restoring the quantized data to the original difference data S115 that has not yet been subjected to the above-mentioned DCT. Then, the adder included in the first encoder 110 adds the difference data S115 outputted from the IDCT unit 115 and the predictive image data S113 generated by the motion compensation unit 111, thereby reconstructing the locally-reproduced image data S114, which is image data to be obtained by a decoding apparatus that receives the first coded data S11, and the reconstructed data is stored in the memory 100.

As described above, in the image coding apparatus 10 according to the first embodiment, the second encoder 120 generates the second coded data S12 as follows. That is, the difference data S111 is generated from the locally-reproduced image data S114 that is reconstructed by the first encoder 110, and the difference data S112 obtained by subjecting the difference data S111 to DCT is quantized by the second quantizer 123 using the second quantization factor, and then the quantized data is coded by the second variable-length encoder 126. Therefore, the image coding apparatus 10 requires only one motion detector, and the second encoder 120 can dispense with the inverse quantizer, IDCT unit, adder, and motion compensation unit.

As described above, since the second encoder 120 includes no inverse quantizer nor IDCT unit, the second coded data S12 is not subjected to inverse quantization nor inverse DCT, that is, it is not restored to the original difference data that has not yet been subjected to DCT. Further, since the second encoder 120 is provided with no motion compensation unit nor adder, the locally-reproduced image data, which is image data to be obtained in a decoding apparatus that receives the second coded data S12, is not reconstructed to be stored in the memory 100. Therefore, when generating the two kinds of coded data S11 and S12 having the same format and different generated code amounts from the single input image S10 in the image coding apparatus 10, the targets to which the memory 100 transfers the data can be limited to the motion detector 118 and the first encoder 110 as in the case of generating a single piece of coded data from a single piece of input image data, and the processing time required for generating the two kinds of coded data S11 and S12 having the same format and different generated code amounts can be approximately equal to the processing time required for generating two kinds of coded data from a single input image by the conventional image coding apparatus 50.

Furthermore, when generating the two kinds of coded data S11 and S12 in the image coding apparatus 10, the amount of data to be transferred to the memory 100 can be made equal to the amount of data obtained when generating a single piece of coded data from a single piece of image data. Therefore, the system cost of the image coding apparatus 10 can be reduced without increasing the transfer ability of the memory 100 in the image coding apparatus 10, or extending the memory interface width, or increasing the data transfer rate.

As described above, according to the first embodiment, the image coding apparatus 10 includes only one motion detector, and the second encoder 120 does not include a motion compensation unit, an adder, a DCT unit, an inverse quantizer, and an IDCT unit. In the second encoder 120, the difference data S111 outputted from the motion compensation unit 111 in the first encoder 110 is subjected to DCT by the DCT unit 112, and the DCT-processed difference data S112 is quantized by the second quantizer 123 and then coded by the second variable-length encoder 126, thereby generating the second coded data S12. Therefore, it is possible to delete, from the flow of generating the second coded data S12, the processes of inversely quantizing the data quantized by the second quantizer 123, subjecting the inversely-quantized data to inverse DCT to restore the data to the original difference data, and reconstructing the locally-reproduced image data on the basis of the restored difference data and the predictive image data outputted from the motion compensation unit. As the result, the circuit scale of the image coding apparatus 10 for generating plural pieces of coded data from a single piece of image data can be significantly reduced, and the processing time required for generating the plural pieces of coded data S11 and S12 from the single piece of image data S10 can be made approximately equal to the processing time required by the conventional image coding apparatus.

Further, in the image coding apparatus 10 according to the first embodiment, even when generating the plural pieces of coded data S11 and S12 from the single piece of input image data S10, the amount of data to be transferred from the memory 100 to the motion detector 118 and the motion compensation unit 111 can be made equal to that in the case of generating a single piece of coded data from a single piece of input image data, resulting in a reduction in system cost of the image coding apparatus 10.

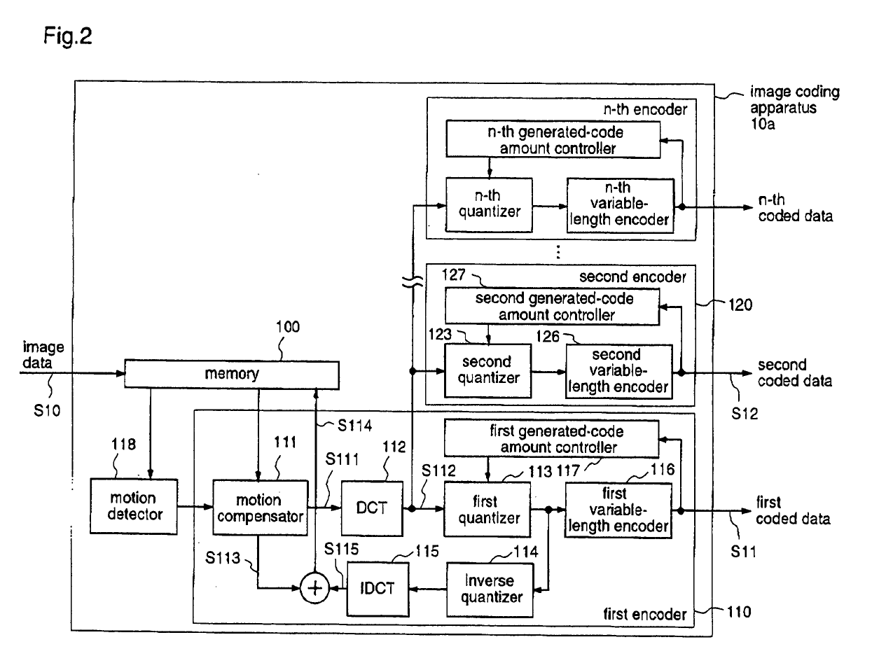

In this first embodiment, the image coding apparatus 10 generates the two kinds of coded data S11 and S12 having the same format and difference code amounts from the single piece of input image data S10. However, the image coding apparatus may be constructed as shown in FIG. 2 when generating two or more pieces of coded data having the same format and different generated code amounts. To be specific, in the image coding apparatus 10a shown in FIG. 2, difference data S111 generated by a first encoder 110 is subjected to DCT, and the DCT-processed difference data is input to the first to n-th quantizers. Then, the input data are quantized in the first to n-th quantizers, and coded in the first to n-th variable-length encoders, thereby obtaining first to n-th coded data, respectively.

Further, a conversion circuit for converting data into a specific format or a data addition circuit (not shown) for adding data such as characteristics of codes may be provided after the first (second) variable length encoder 116 (126). In this case, it is possible to generate plural pieces of coded data having the same format and different stream types, such as a program stream (PS) and a transport stream (TS) of MPEG2, from a single piece of input image data. Further, the first and second encoders 110 and 120, the first and second quantizers 113 and 123, the first and second variable-length encoders 116 and 126, and the first and second generated code amount controllers 117 and 127 may have different constructions from each other, respectively. In this case, it is possible to generate plural pieces of coded data having different formats, such as MPEG1, MPEG2, and MPEG4, from a single piece of input image data.

Furthermore, it is possible to generate coded data for radio and coded data for cable from a single piece of input image data by appropriately combining the above-mentioned constructions. Further, it is also possible to generate coded data for communication lines and coded data for storage media from a single piece of input image data by variably controlling the code amount with one of the first and second generated code amount controllers 117 and 127 while fixedly controlling the same with the other controller. Thus, plural pieces of coded data can be generated by combining appropriate ones selected from among different generated code amount control methods, different formats, and different stream types.

[Embodiment 2]

Hereinafter, an image coding apparatus according to a second embodiment of the present invention will be described with reference to FIG. 1.

In the image coding apparatus according to the second embodiment, the first and second generated code amount controllers perform control so that the generated code amount of the first coded data becomes larger than the generated code amount of the second coded data.

Since the construction of the image coding apparatus according to the second embodiment is identical to that of the image coding apparatus 10 according to the first embodiment, repeated description is not necessary.

As described for the first embodiment, the image coding apparatus 10 includes only one motion detector, and the second encoder 120 does not include a motion compensation unit, an adder, a DCT, an inverse quantized, and an inverse DCT. Further, motion detection and reconstruction of the locally-reproduced image data are eliminated from the flow of generating the second coded data S12 by the second encoder 120, and the second encoder 120 receives the locally-reproduced image data S114 generated by the first encoder 110 and the DCT-processed difference data S112 obtained by subjecting the difference data S111 to DCT, and thereafter, the DCT-processed difference data 112 is quantized and coded by the second quantizer 123 and the second variable-length encoder 126, respectively, thereby generating the second coded data S12. In the image coding apparatus 10 constructed as described above, since the process of reconstructing the locally-reproduced image data based on the second coded data S12 is eliminated from the flow of generating the second coded data S12, the circuit scale and the processing time required for coding are hardly increased as compared with those of the image coding apparatus for generating a single piece of coded data from a single piece of input image data, resulting in a reduction in system cost. However, at the decoding apparatus end that receives and decodes not the locally-reproduced image data reconstructed by the first encoder 110 but the second coded data S12 that is generated from the difference data S112 between the locally-reproduced image data reconstructed by the first encoder 110 and the input image data S10, errors are accumulated when decoding the second coded data, whereby a favorable image cannot be obtained.

Hereinafter, this problem will be described in more detail. First of all, in the first encoder 110, the difference data S111 is generated by the motion compensation unit 111 using the motion vector detected by the motion detector 118, and the difference data S111 is subjected to DCT by the DCT unit 112. Then, the DCT-processed difference data S112 is quantized by the first quantizer 112 using the first quantization factor, and the quantized data is input to the first variable-length encoder 116 to generate the first coded data S11. Then, the quantized data is input to the inverse quantizer 114 to be inversely quantized, and the inversely-quantized data is subjected to inverse DCT, thereby to restore the data to the original difference data S115 that has not yet been subjected to DCT. Then, the difference data S115 is added to the predictive image data S113 supplied from the motion compensation unit 111, thereby to reconstruct the locally-reproduced image data S114 which is image data to be obtained in the decoding apparatus for receiving the first coded data S111, and thereafter, the locally-reproduced image data S114 is stored in the memory 100.

Although the inverse quantizer 114 and the IDCT 115 perform processes inverse to those of the first quantizer 113 and the DCT 112, the difference data S115 which has been subjected to inverse quantization and inverse DCT by the inverse quantizer 114 and the IDCT unit 115 is not completely identical to the difference data S111 which is outputted from the motion compensation unit 111, resulting in an error (hereinafter referred to as a first error). However, since this first error occurs when generating the first coded data S11, it is not stored in the decoding apparatus (not shown) that receives the first coded data S11 and decodes the data S11 by performing processes inverse to those of the respective constituents of the first encoder 110.

On The other hand, in the second encoder 120, as described above, the locally-reproduced image data based on the second coded data S12 is not reconstructed, and the difference data S111 with respect to the input image data S10 is generated using the difference data S115 including the first error that occurs in the first encoder 110, and the locally-reproduced image data S114 reconstructed by the predictive image data S113. Then, the second encoder 120 receives, from the first encoder 110, the difference data S112 that is obtained by subjecting the difference data S111 to DCT, and quantizes and encodes the received difference data S112 to generate the second coded data S12. Accordingly, when generating the second coded data S12, an error (hereinafter referred to as a second error) is caused by that the second coded data S12 is generated using the locally-reproduced image data S114 including the first error that occurs in the first encoder 110. Since this second error includes the first error as described above, this error cannot be canceled but is stored in the decoding apparatus (not shown) that receives the first coded data S12 and decodes the second coded data S12 by performing processes inverse to those of the respective constituents of the second encoder 120.

In the image coding apparatus according to the second embodiment, the first and second generated code amount controllers 117 and 127 perform control so that the code amount of the first coded data becomes larger than that of the second coded data S12, thereby to minimize the first error which occurs between the difference data S115 that is obtained by subjecting the data quantized by the first quantizer 113 to inverse quantization and IDCT, and the difference data S111 supplied from the motion compensation unit 111, as well as the second error included in the first error. In this way, the second error is minimized in the decoding apparatus that receives and decodes the second coded data S12, resulting in a favorable image obtained when decoding the second coded data S12.

As described above, in the image coding apparatus 10 according to the second embodiment, since the code amount of the first coded data S31 and the code amount of the second coded data S12 are controlled so that the former becomes larger than the latter, the first error that occurs when generating the first coded data S11 can be minimized, and simultaneously, the second error that occurs when generating the second coded data S12 can also be minimized, resulting in a favorable image obtained in the decoding apparatus that receives and decodes the second coded data S12.

Furthermore, when performing control so that the generated code amount of the first coded data becomes larger than that of the second coded data, the second generated code amount controller 127 controls the code amounts of the intra-frame coded image (I picture) and the inter-frame forward predictive coded image (P picture) so that the code amounts become equal to those obtained by the first controller 117 while the second controller 127 controls the code amount of the inter-frame bidirectional predictive coded image (B picture) so that the code amount becomes different from that obtained by the first controller 117, for example, so that the first generated code amount becomes larger than the second generated code amount. Thereby, the first error can be further reduced, and the second error can also be reduced with the reduction in the first error. As a result, more favorable image quality can be obtained in a decoding apparatus that receives and decodes the second coded data S12.

While in this second embodiment two kinds of coded data of the same format and different generated code amounts are generated, the image coding apparatus may be constructed as shown in FIG. 2 in which the code amount controller controls the code amount of the first coded data so that it becomes larger than the code amounts of the second to n-th coded data, as described for the first embodiment. Also in this case, favorable images can be obtained in the respective decoding apparatuses for receiving and decoding the second to n-th coded data.

Further, as described for the first embodiment, a conversion circuit for converting data into a specific format or a data addition circuit (not shown) for adding data such as characteristics of codes may be provided after the first (second) variable length encoder 116 (126). In this case, it is possible to generate plural pieces of coded data having the same format and different stream types, such as a program stream (PS) and a transport stream (TS) of MPEG2, from a single piece of input image data. Further, the first and second encoders, the first and second quantizers, the first and second variable-length encoders, and the first and, second generated code amount controllers may have different constructions from each other, respectively. In this case, it is possible to generate plural pieces of coded data having different formats, such as MPEG1, MPEG2, and MPEG4, from a single piece of input image data.

[Embodiment 3]

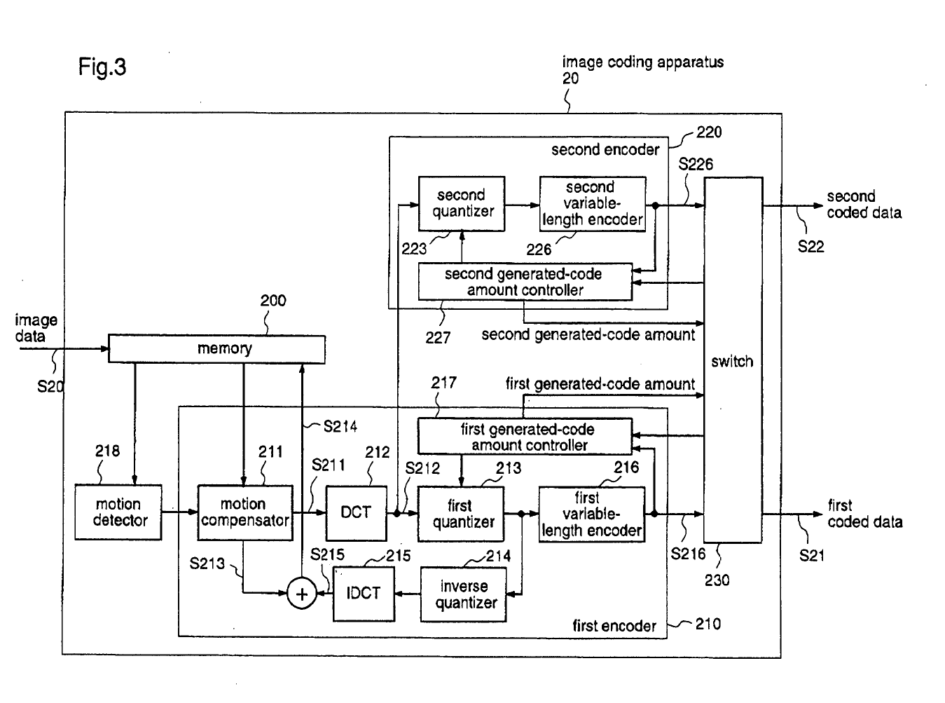

Hereinafter, an image coding apparatus according to a third embodiment of the present invention will be described with reference to FIGS. 3 to 5.

In this third embodiment, when generating a plurality of coded data having the same format and different generated code amounts from a single piece input image data, an image coding apparatus as described for the first embodiment is provided with a switch, and the switch is controlled so that the code amount of the coded data generated in the first encoder is always larger than the code amount of the coded data generated in the second encoder.

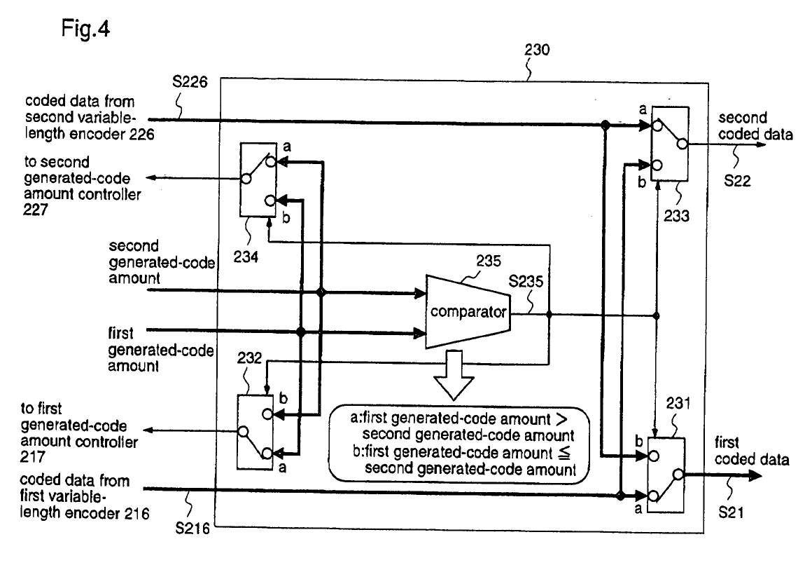

Initially, the construction of an image coding apparatus 20 according to a third embodiment will be described with reference to FIGS. 3 and 4. FIG. 3 is a block diagram illustrating the image coding apparatus 20 according to the third embodiment, and FIG. 4 is a block diagram illustrating a switch included in the image coding apparatus 20.

In FIG. 3, the image coding apparatus 20 is obtained by providing the image coding apparatus 10 according to the first embodiment with a switch 230 which selects either coded data S216 outputted from the first variable-length encoder 210 or coded data S226 outputted from the second variable-length encoder 226, according to first and second code amounts. As shown in FIG. 4, the switch 230 is provided with first to fourth selectors 231˜234, and a comparator 235 for comparing the first and second code amounts.

Next, the operation of the image coding apparatus 20 according to the third embodiment will be described.

Initially, image data S20 supplied from the outside to the image coding apparatus 20 is stored in the memory 200. The image data stored in the memory 200 is input to the motion detector 218, wherein a motion vector is obtained. Then, predictive image data S213 is generated with reference to the locally-reproduced image data S214 stored in the memory 200, using the motion vector detected by the motion detector 218, and the generated data S213 is output to the adder in the first encoder 210. Further, a difference between the predictive image data S213 and the input image data S20 is obtained to he output as difference data S211 to the DCT 212.

The difference data S211 obtained in the motion compensation unit 211 is subjected to DCT by the DCT 212, and the DCT-processed difference data S212 is input to the first quantizer 213 and the second quantizer 223 in the second encoder 220. In the first and second quantizers 213 and 223, the DCT-processed difference data S212 is subjected to quantization, i.e., divided by the first and second quantization factors, respectively. Thereafter, the quantized data are coded in the first and second variable-length encoders 216 and 226 to obtain coded data S216 and S226, respectively. Then, the coded data S216 and S226 obtained in the first and second variable-length encoders 216 and 226 are input to the switch 230, respectively. At the same time, the coded data S216 and S226 obtained in the first and second variable-length encoders 216 and 226 are also input to the first and second generated code amount controllers 217 and 227, wherein first and second code amounts of the coded data S216 and S226 outputted from the first and second variable-length encoders 216 and 226 are detected to be output to the switch 230.

In the switch 230, initially, the first and second generated code amounts are received by the comparator 235 and the second and fourth selectors 232 and 234, and the coded data S216 and s226 from the first and second variable-length encoders 216 and 226 are received by the first selector 231 and the third selector 233, respectively. Then, in the comparator 235, the first generated code amount and the second generated code amount are compared, and a control signal S235 based on the result of comparison is output to the respective selectors 231 to 234.

For example, when the comparator 235 judges that the first generated code amount is larger than the second generated code amount, the comparator 235 outputs a control signal S235 that instructs the respective selectors 231˜234 to select “a”. On receipt of the control signal S235, the selectors 231˜234 output the coded data S216 supplied from the first variable-length encoder 216, as the first coded data S21, and output the coded data S226 supplied from the second variable-length encoder 226, as the second coded data S22, and further, output the first generated code amount to the first generated code amount controller 217 and the second generated code amount to the second generated code amount controller 227. On the other hand, when the comparator 235 judges that the first generated code amount is equal to or smaller than the second generated code amount, the comparator 235 outputs a control signal S235 that instructs the respective selectors 231˜234 to select “b”. On receipt of the control signal S235, the selectors 231˜234 output the coded data S226 of the second variable-length encoder 226, as the first coded data S21, and output the coded data S216 of the first variable-length encoder 216, as the second coded data S22, and further, output the second generated code amount to the first generated code amount controller 217 and the first generated code amount to the second generated code amount controller 227.

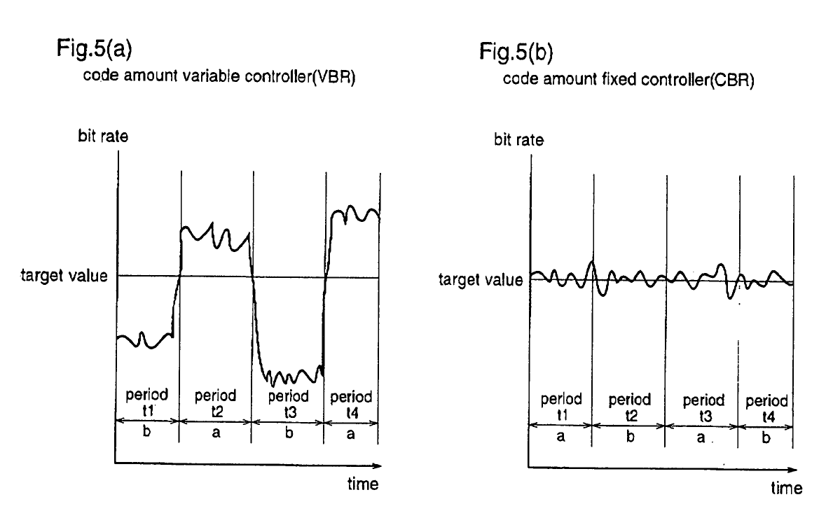

Hereinafter, the operation will be described in more detail with reference to FIG. 5. FIG. 5(a) shows the case where the code amount is variably controlled by the generated code amount controller, and FIG. 5(b) shows the case where the code amount is fixedly controlled.

For example, the code amount of the coded data generated in the variable-length encoder is fixedly controlled by the first generated code amount controller (refer to FIG. 5(b)) and variably controlled by the second generated code amount controller (refer to FIG. 5(a)). In this case, in the image coding apparatus 10 according to the first embodiment, the code amount of the first coded data S11 is larger than that of the second coded data S12 during the periods t1 and t3 while the code amount of the second coded data S12 is larger than that of the first coded data S11 during the periods t2 and t4. In order to avoid such situation and make the code amount of the first coded data be always larger than the code amount of the second coded data, initially the comparator 235 in the switch 230 compares the first and second code amounts. During the period when the code amount of the first coded data is larger than the code amount of the second coded data (t1, t3 in FIG. 5(a), 5(b)), the control signal S235 from the comparator 235 instructs the respective selectors 231˜234 to select “a”, whereby the coded data S216 from the first variable-length encoder 216 is output as the first coded data S21 while the coded data S226 from the second variable-length encoder 226 is output as the second coded data S22. On the other hand, during the period when the code amount of the first coded data is equal to or smaller than the code amount of the second coded data (t2, t4 period in FIG. 5(a), (b)), the control signal S235 from the comparator 235 instructs the respective selectors 231˜234 to select “b”, whereby the coded data S226 from the second variable-length encoder 226 is output as the first coded data S21 while the coded data S216 from the first variable-length encoder 216 is output as the second coded data S22.

As described above, in the switch 230, the first and second code amounts detected by the first and second code amount controllers 217 and 227 are compared, and the larger code amount is always selected as the first coded data S21, whereby the code amount of the first coded data S21 can always be made larger than the code amount of the second coded data S22. In addition, the information of the code amount to be output from the switch 230 to the first and second code amount controllers 217 and 227 is also switched so that the coded data of the larger code amount is always output to the first code amount controller 217, whereby such as the first and second quantization factors of the first and second quantizers 213 and 223 can always be controlled according to the first and second coded data S21 and S22 by the first and second generated code amount controllers 217 and 227, respectively, so that the first code amount becomes always larger than the second code amount.

As described above, the image coding apparatus 20 according to the third embodiment is provided with the switch 230, and the comparator 235 included in the switch 230 compares the code amounts of the respective coded data S216 and S226 which are obtained in the first and second variable-length encoders 216 and 226, respectively, and the first and second coded data S21 and S22 outputted from the image coding apparatus 20 can be controlled so that the code amount of the first coded data S21 is always larger than that of the second coded data S22, whereby the first error that occurs when generating the first coded data 521 can always be reduced in the image coding apparatus 20. With the reduction in the first error, the second error that occurs when generating the second coded data S22 can also be reduced, resulting in more favorable image quality in the decoding apparatus that receives and decodes the second coded data S22.

Further, in the above-mentioned construction, the coded data of the larger code amount and the coded data of the smaller code amount can be adaptively applied to a network of a broader transmission band (cable) and to a network of a narrower transmission band (radio), respectively.

What is claimed is:

1. An image coding apparatus for outputting a plurality of coded data of different types from a single input image, comprising:
a motion detector for obtaining a motion vector of the input image;
a first encoder for subjecting the input image to motion compensation using the motion vector obtained by the motion detector, quantizing the data that is obtained by subjecting the motion-compensated data to orthogonal transformation, and subjecting the orthogonally-transformed data to variable length coding, thereby generating first coded data; and
n (n: integer, n≧1) pieces of encoders, each receiving the data that is orthogonally-transformed by the first encoder, quantizing the data, and subjecting the quantized data to variable-length coding, thereby generating coded data.

2. An image coding apparatus as defined in claim 1 wherein
said first encoder comprises a motion compensation unit for subjecting the input image to motion compensation using the motion vector, an orthogonal transformer for subjecting the motion-compensated data to orthogonal transformation, a first quantizer for quantizing the orthogonally-transformed data, an inverse quantizer for inversely quantizing the quantized data, an inverse orthogonal transformer for subjecting the inversely-quantized data to inverse orthogonal transformation, a first variable-length encoder for subjecting the quantized data to variable-length coding to generate first coded data, and a generated code amount controller for controlling the first quantizer on the basis of the code amount of the first coded data that is generated by the first variable-length encoder; and
each of said n pieces of encoders comprises a quantizer for quantizing the data that is orthogonally-transformed by the first encoder, a variable-length encoder for subjecting the quantized data to variable-length coding to generate coded data, and a generated code amount controller for controlling the quantizer on the basis of the code amount of the coded data obtained by the variable-length encoder.

3. An image coding apparatus as defined in claim 2 wherein said n pieces of encoders perform coding to generate n pieces of coded data so that the code amount of the n pieces of coded data becomes smaller than the code amount of the first coded data.

4. An image coding apparatus as defined in claim 3 wherein said n pieces of encoders perform coding to generate n pieces of coded data so that an intra-frame coded image and an inter frame forward direction predictive coded image have the same code amount as the code amount of the first coded data, while an inter-frame bidirectional predictive coded image has a code amount that is smaller than the code amount of the first coded data.

5. An image coding apparatus as defined in claim 2 wherein the first coded data and the n pieces of coded data, which are respectively outputted from the first encoder and the n pieces of encoders, are coded data having the same format and different generated code amounts.

6. An image coding apparatus as defined in claim 2 wherein the first coded data and the n pieces of coded data, which are respectively outputted from the first encoder and the n pieces of encoders, are coded data having different formats.

7. An image coding apparatus as defined in claim 2 wherein the first coded data and the n pieces of coded data, which are respectively outputted from the first encoder and the n pieces of encoders, are coded data having the same format and different stream types.

8. An image coding apparatus for outputting two different types of coded data from a single input image, comprising:
a motion detector for obtaining a motion vector of the input image;
a first encoder for subjecting the input image to motion compensation using the motion vector obtained by the motion detector, quantizing the data that is obtained by subjecting the motion-compensated data to orthogonal transformation, and subjecting the orthogonally-transformed data to variable length coding, thereby generating first coded data; and
a second encoder for receiving the data that is orthogonally-transformed by the first encoder, quantizing the data, and subjecting the quantized data to variable-length coding, thereby generating second coded data.

9. An image coding apparatus as defined in claim 8 wherein
said first encoder comprises a motion compensation unit for subjecting the input image to motion compensation using the motion vector, an orthogonal transformer for subjecting the motion-compensated data to orthogonal transformation, a first quantizer for quantizing the orthogonally-transformed data, an inverse quantizer for inversely quantizing the quantized data, an inverse orthogonal transformer for subjecting the inversely-quantized data to inverse orthogonal transformation, a first variable-length encoder for subjecting the quantized data to variable-length coding to generate first coded data, and a generated code amount controller for controlling the first quantizer on the basis of the code amount of the first coded data that is generated by the first variable-length encoder; and
said second encoder comprises a second quantizer for quantizing the data that is orthogonally-transformed by the first encoder, a second variable-length encoder for subjecting the quantized data to variable-length coding to generate second coded data, and a second generated code amount controller for controlling the second quantizer on the basis of the code amount of the second coded data obtained by the second variable-length encoder.

10. An image coding apparatus as defined in claim 9 wherein one of the first generated code amount controller and the second generated code amount controller variably controls the generated code amount while the other controller fixedly controls the code amount.

11. An image coding apparatus as defined in claim 10 further comprising:
a switch for comparing the code amount of the first coded data and the code amount of the second coded data, and switching the output data between the first coded data and the second coded data on the basis of the result of comparison;
wherein the first coded data is output as first coded data while the second coded data is output us second coded data when the code amount of the first coded data is larger than the code amount of the second coded data; and
the second coded data is output as first coded data while the first coded data is output as second coded data when the code amount of the first coded data is equal to or smaller than the code amount of the second coded data.

12. An image coding apparatus as defined in claim 9 wherein the first coded data outputted from the first encoder is coded data in a format for cable, and the second coded data outputted from the second encoder is coded data in a format for radio.

13. An image coding apparatus as defined in claim 9 wherein the first coded data outputted from the first encoder is coded data in a format for storage media, and the second coded data outputted from the second encoder is coded data in a format for communication lines.
